(19) United States
(12) Patent Application Publication
(10) Pub. No.: US 2023/0215201 A1
(43) Pub. Date: Jul. 6, 2023

(54) IDENTIFY CARD NUMBER

(71) Applicant: BEIIJNG SANKUAI ONLINE TECHNOLOGY CO., LTD, Beijing (CN)

(72) Inventor: Tianqi HONG, Beijing (CN)

(21) Appl. No.: 17/473,897

(22) PCT Filed: Nov. 26, 2019
(86) PCT No.: PCT/CN2019/121053

§ 371 Date: Sep. 13, 2021

(30) Foreign Application Priority Data
Mar. 14, 2019 (CN) 201910195326.7

(51) Int. Cl. G06V 30/148; G06V 30/19; G06V 10/774

(52) U.S. Cl. CPC G06V 30/158; G06V 30/19173; G06V 10/774; G06V 30/153

(57) ABSTRACT

A card number recognition method and apparatus, a storage medium, and an electronic device are disclosed. The method includes: obtaining distribution format information of character bits of a card number sequence, where the distribution format information includes character bit spacing information of the card number sequence; recognizing a character sequence in a target image through a neural network model trained in advance, and obtaining character bit spacing information of the recognized character sequence; determining whether the character bit spacing information of the recognized character sequence is consistent with the character bit spacing information in the obtained distribution format information; and if the character bit spacing information of the character sequence is consistent with the character bit spacing information in the obtained distribution format information, determining that the recognized character sequence is target card numbers.

### CROSS-REFERENCE TO RELATED APPLICATIONS

The present disclosure claims priority to Chinese Patent Application No. 201910195326.7, filed with the China National Intellectual Property Administration on Mar. 14, 2019, and entitled “CARD NUMBER RECOGNITION METHOD AND APPARATUS, STORAGE MEDIUM, AND ELECTRONIC DEVICE”, which is incorporated herein by reference in its entirety.

### TECHNICAL FIELD

The present disclosure relates to the field of image recognition, and specifically, to a card number recognition method and apparatus, a storage medium, and an electronic device.

### BACKGROUND

With the development of technologies, there are more and more scenarios in which users implement various services through networks. In a process of processing services through networks, it is inevitable to use card numbers of people, for example, ID card numbers and bank card numbers.

Because a number sequence of card numbers is usually long and difficult to remember, a manual input manner is not sufficiently fast and easy to have a mistake. As a result, this affects user experience in processing a service and increases time for online service processing. Therefore, as a function of shortening time for online service processing of users, card number recognition plays an important role in a process of online service processing.

### SUMMARY

The present disclosure provides a card number recognition method and apparatus, a storage medium, and an electronic device.

According to a first aspect of the present disclosure, a card number recognition method is provided, including:

obtaining distribution format information of character bits of a card number sequence, where the distribution format information includes character bit spacing information of the card number sequence; recognizing a character sequence in a target image through a neural network model trained in advance, and obtaining character bit spacing information of the recognized character sequence; determining whether the character bit spacing information of the recognized character sequence is consistent with the character bit spacing information in the obtained distribution format information; and if the character bit spacing information of the character sequence is consistent with the character bit spacing information in the obtained distribution format information, determining that the recognized character sequence is target card numbers.

According to a second aspect, the present disclosure provides a data processing apparatus. The apparatus includes:

a format obtaining module, configured to obtain distribution format information of character bits of a card number sequence, where the distribution format information includes character bit spacing information of the card number sequence; a recognition module, configured to: recognize a character sequence in a target image through a neural network model trained in advance, and obtain character bit spacing information of the recognized character sequence; a judging module, configured to determine whether the character bit spacing information of the recognized character sequence is consistent with the character bit spacing information in the obtained distribution format information; and a determining module, configured to: when it is determined that the character bit spacing information of the character sequence is consistent with the character bit spacing information in the distribution format information, determine that the recognized character sequence is target card numbers.

According to a third aspect, the present disclosure provides a nonvolatile computer-readable storage medium, storing a computer program, where when the program is executed by a processor, the processor is enabled to perform the following operations:

obtaining distribution format information of character bits of a card number sequence, where the distribution format information includes character bit spacing information of the card number sequence; recognizing a character sequence in a target image through a neural network model trained in advance, and obtaining character bit spacing information of the recognized character sequence; determining whether the character bit spacing information of the recognized character sequence is consistent with the character bit spacing information in the obtained distribution format information; and if the character bit spacing information of the character sequence is consistent with the character bit spacing information in the obtained distribution format information, determining that the recognized character sequence is target card numbers.

According to a fourth aspect, the present disclosure provides an electronic device, including: a memory, storing a computer program; and a processor, configured to execute the computer program in the memory, to perform the following operations:

obtaining distribution format information of character bits of a card number sequence, where the distribution format information includes character bit spacing information of the card number sequence; identifying a character sequence in a target image through a neural network model trained in advance, and obtaining character bit spacing information of the identified character sequence; determining whether the character bit spacing information of the identified character sequence is consistent with the character bit spacing information in the obtained distribution format information; and if the character bit spacing information of the character sequence is consistent with the character bit spacing information in the obtained distribution format information, determining that the identified character sequence is target card numbers.

Other features and advantages of the present disclosure will be described in detail in the following detailed description part.

### BRIEF DESCRIPTION OF THE DRAWINGS

The accompanying drawings are intended to provide further understanding of the present disclosure and constitute a part of this specification. The accompanying drawings and the specific implementations below are used together for explaining the present disclosure rather than constituting a limitation to the present disclosure.

FIG. 1A is a flowchart of a card number recognition method according to an exemplary embodiment;

FIG. 1B is a schematic diagram of a card number recognition method according to an exemplary embodiment;

FIG. 2A is a flowchart of a card number recognition method according to another exemplary embodiment;

FIG. 2B is a schematic diagram of a virtual detection strip according to an exemplary embodiment;

FIG. 2C is a schematic diagram of distribution of a sampling window according to an exemplary embodiment;

FIG. 2D is a schematic diagram of performing image recognition based on a sampling window according to an exemplary embodiment;

FIG. 2E is a schematic diagram of a sub-image obtained in a sampling window according to an exemplary embodiment;

FIG. 3 is a block diagram of a card number recognition apparatus according to an exemplary embodiment;

FIG. 4 is a block diagram of an electronic device for card number recognition according to an exemplary embodiment; and

FIG. 5 is a block diagram of an electronic device for card number recognition according to another exemplary embodiment.

### DETAILED DESCRIPTION OF THE EMBODIMENTS

Specific implementations of the present disclosure are described in detail below with reference to the accompanying drawings. It should be understood that the specific implementations described herein are merely used to describe and explain the present disclosure, but are not intended to limit the present disclosure.

In an example, the following method is provided: dividing a card number region into a plurality of card number sub-regions, extracting a feature of each card number sub-region through a convolutional neural network, and inputting the feature of each card number sub-region into a classifier to obtain card numbers in a current image. In this solution, there are a plurality of steps such as image division and recognition, and an error in any step may affect accuracy of a subsequent step. In this method, because division of sub-regions depends on a machine algorithm, there may be a number in the boundary between sub-regions. As a result, one number may be recognized in a plurality of sub-regions, resulting in recognition for a plurality of times, or a number in each sub-region cannot be recognized, resulting in missed recognition. Accordingly, an unnecessary bit may be present or a necessary bit may be absent in the recognized card numbers. A recognition error in this scenario is difficult to be recognized in a subsequent step, affecting accuracy of card number recognition.

In view of this, the embodiments of the present disclosure provide a card number recognition method, which can improve accuracy of card number recognition.

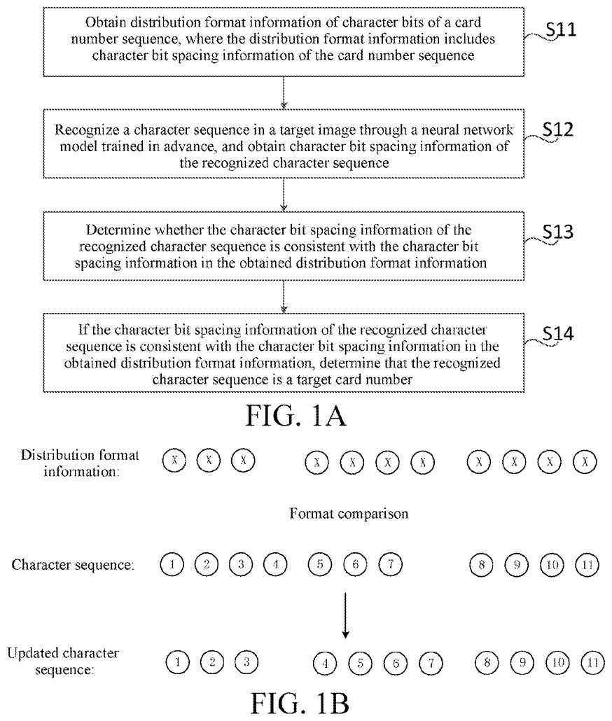

FIG. 1A is a flowchart of a card number recognition method according to an exemplary embodiment. The method includes the following steps:

S11: Obtain distribution format information of character bits of a card number sequence, where the distribution format information includes character bit spacing information of the card number sequence.

In this step, the distribution format information of the character bits of the card number sequence may be determined by determining character positions and character spacing of card numbers. The distribution format information in this step may be default distribution format information in a current recognition mode, or may be distribution format information in a preset table, or may be distribution format information obtained by preprocessing a card image.

For example, when the distribution format information is the default distribution format information in the current recognition mode, the current recognition mode may be recognition of an ID card image, the distribution format information correspondingly may be XXXXXXXXXXXXXXXXXX (a quantity of numbers and an arrangement rule), and spacing between numbers is N pixels (character bit spacing information). In this case, the character bit spacing information is (N, N, N, N, N, N, N, N, N, N, N, N, N, N, N, N, N). In another example, the current recognition mode may alternatively be recognition of a bank card image of a particular bank. In this case, according to a card number format of the bank card of the particular bank, the distribution format information may be XXX-XXXX-XXXX-XXXX (a quantity of numbers and an arrangement rule), spacing between adjacent numbers is N1 pixels, and a corresponding spacing at the “-” character is N2 pixels. In this case, the character bit spacing information is (N1, N1, N2, N1, N1, N1, N2, N1, N1, N1, N2, N1, N1, N1).

In addition to a specific pixel value, a unit length may alternatively be used to represent a character bit spacing. For example, a sequence in a format of XXX-XXXX may be arranged as X-X-X---X-X-X-X on a target image. In this case, a spacing between adjacent numbers of the first number, the second number, and the third number is 1 unit length, a spacing between the third number and fourth number is 3 unit lengths, and a spacing between adjacent numbers of the fourth number, the fifth number, the sixth number, and the seventh number is 1 unit length.

The character bit spacing may vary in different types of card numbers. For example, in some credit cards, a three-bit check code exists after primary card numbers, and the three-bit check code is far away from the primary card numbers. In this case, a distribution format may be expressed as XXX-XXXXXXX-XXXX----xxx (the three-bit check code). If expressed by a pixel value, the primary card numbers and the three-bit check code may be (4, 4, 10, 4, 4, 4, 4, 4, 4, 10, 4, 4, 4, 25, 4, 4). If expressed by a unit length, the primary card numbers and the three-bit check code may be arranged as XXX---XXXXXXX---XXXX xxx on a target image. In this case, a spacing between adjacent numbers of the first number, the second number, and the third number is 1 unit length, a spacing between the third number and fourth number is 3 unit lengths, . . . , and a spacing between the fourteenth number and the fifteenth number is 8 unit lengths, and so on.

In a possible implementation, type information of the card number may be obtained, and the distribution format information of the character bit of the card number sequence is determined according to the type information of the card number and a correspondence between a preset card number type and distribution format information of the card number.

That is, distribution format information of a corresponding card number sequence may be determined based on different card categories, different banks, and different card types (that is, type information) of cards. For example, if the card is ID card and a card number distribution format of the ID card numbers is an 18-bit code not containing any spacer, corresponding distribution format information may be (4, 4, 4, 4, 4, 4, 4, 4, 4, 4, 4, 4, 4, 4, 4, 4, 4), and a sequence format is determined as XXXXXXXXXXXXXXXXXX. If the card is a debit card and an issuing bank is Industrial and Commercial Bank of China, and a card number distribution format of the debit card of Industrial and Commercial Bank of China is XXXXXX-XXXXXXXXXXXXX, corresponding distribution format information may be (4, 4, 4, 4, 4, 10, 4, 4, 4, 4, 4, 4, 4, 4, 4, 4, 4, 4), and a sequence format is determined as XXXXXX-XXXXXXXXXXXXX. If the card is a credit card and an issuing bank is China Construction Bank, and a card number distribution format of the credit card of China Construction Bank is XXXX-XXXX-XXXX-XXXX, corresponding distribution format information may be (4, 4, 4, 10, 4, 4, 4, 10, 4, 4, 4, 10, 4, 4, 4), and a sequence format is determined as XXXX-XXXX-XXXX-XXXX.

It should be noted that type information of card numbers may be determined by recognizing a pattern of card background, or determined based on a type and a progress of a processed service. For example, if a user is applying for a loan service and is in a progress of entering ID card numbers, it may be determined that a card image entered by the user belongs to an ID card type.

S12: Recognize a character sequence in a target image through a neural network model trained in advance, and obtain character bit spacing information of the recognized character sequence.

In this step, the character sequence in the target image may be recognized, and a spacing between characters is determined based on pixel positions of characters in the character sequence, to determine character bit spacing information of the recognized character sequence.

For example, the recognized character sequence may be 123-4567-1234-1234, where a character spacing between adjacent characters is 4 pixels and a spacing corresponding to the “-” character is 10 pixels. In this case, the character bit spacing information is (4, 4, 10, 4, 4, 4, 10, 4, 4, 4, 10, 4, 4, 4).

S13: Determine whether the character bit spacing information of the recognized character sequence is consistent with the character bit spacing information in the obtained distribution format information.

In this step, it may be determined whether the character bit spacing information of the character sequence that is obtained in S12 is consistent with the character bit spacing information in the distribution format information that is obtained in S11.

For example, the character bit spacing information obtained in the distribution format information is (4, 4, 4, 10, 4, 4, 10, 4, 4, 4), and represents a total of 11 numbers. In addition, because a spacing between the fourth number and the fifth number and a spacing between the seventh number and the eighth number are obviously larger than that between other positions, it may be determined that a sequence format is XXXX-XXX-XXXX. However, the character bit spacing information obtained in the character sequence is (4, 4, 19, 4, 4, 10, 4, 4, 4). Therefore, a sequence format is determined as XXX-XXX-XXXX, and character bit spacing information of the third number and the fourth number is obviously inconsistent with character spacing information in the distribution format information. Therefore, this indicates that recognition of the third number and the fourth number is wrong.

It should be noted that because of different shooting angles and lighting conditions of the card, character bit spacing information may not completely correspondingly consistent. Therefore, an error range may be preset. If a difference between the character bit spacing information of the character sequence and the character bit spacing information in the distribution format information falls within the error range, it may also be considered that the character bit spacing information of the character sequence and the character bit spacing information in the distribution format information are consistent.

S14: If the character bit spacing information of the recognized character sequence is consistent with the character bit spacing information in the obtained distribution format information, determine that the recognized character sequence is target card numbers.

When the character bit spacing information of the character sequence is consistent with the character bit spacing information in the distribution format information, the character sequence is highly possibly correct, and it may be determined that the character sequence is target card numbers.

In an optional implementation, if the character bit spacing information of the recognized character sequence is inconsistent with the character bit spacing information in the distribution format information, the character sequence may be updated according to the distribution format information.

Specifically, the character sequence may be updated in the following manner deleting a character that does not conform to the distribution format information from the character sequence, determining, in the target image, an update sub-image whose pixel position satisfies a character bit of the distribution format information, and updating the character sequence according to a recognition result of the update sub-image.

For example, as shown in FIG. 1B, a character sequence format represented by the character bit spacing information in the distribution format information is XXX-XXXX-XXXX (the first row), and a character sequence format represented by the character bit spacing information of the character sequence is XXXX-XXX-XXXX (the second row, where numbers represent a sequence of characters). It may be determined that the fourth character in the character sequence is recognized for a plurality of times, and a character between the seventh character and the eighth character is not recognized. The fourth character in the character sequence may be deleted, an update sub-image is determined in a pixel position between pixel positions corresponding to the seventh character and the eighth character, content of the update sub-image is recognized again to determine a result of a character between the seventh character and the eighth character, the character sequence is updated to XXX-XXXX-XXXX (the third row, where numbers represent a sequence of characters) according to the result of the character, and it is determined that the updated character sequence is target card numbers.

In this embodiment of the present disclosure, it is determined whether there is a recognition error according to a character spacing of card numbers, a character string may be recognized, and a character string is corrected based on a spacing between character strings arranged orderly. Therefore, the method provided in this embodiment of the present disclosure can be applied to recognize and correct a character string arranged orderly.

The above technical solution can achieve at least the following technical effects: a format of the recognized character sequence is compared with that in the distribution format information, so that it may be determined whether the format of the recognized character sequence is consistent with the format in the distribution format information. If the format of the recognized character sequence is consistent with the format in the distribution format information, the target card numbers are outputted. Therefore, this can reduce recognition errors caused by extra or missing characters, thereby improving accuracy of card number recognition.

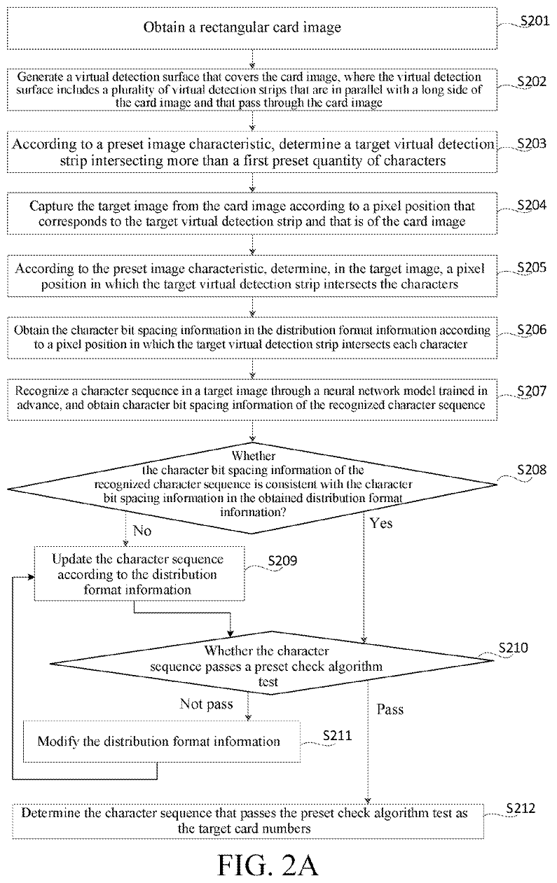

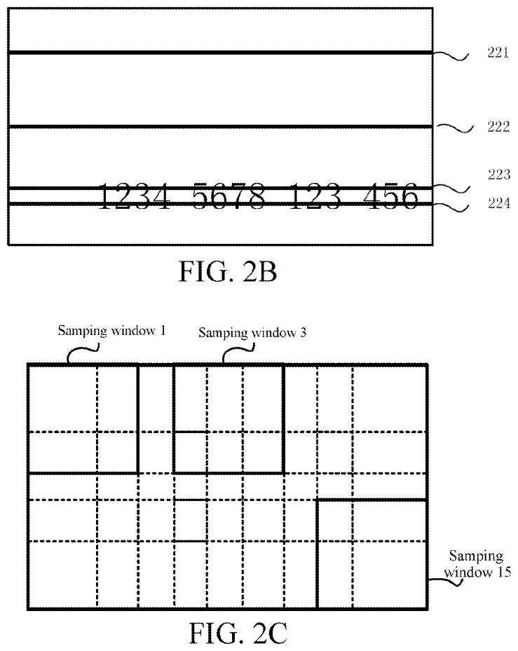

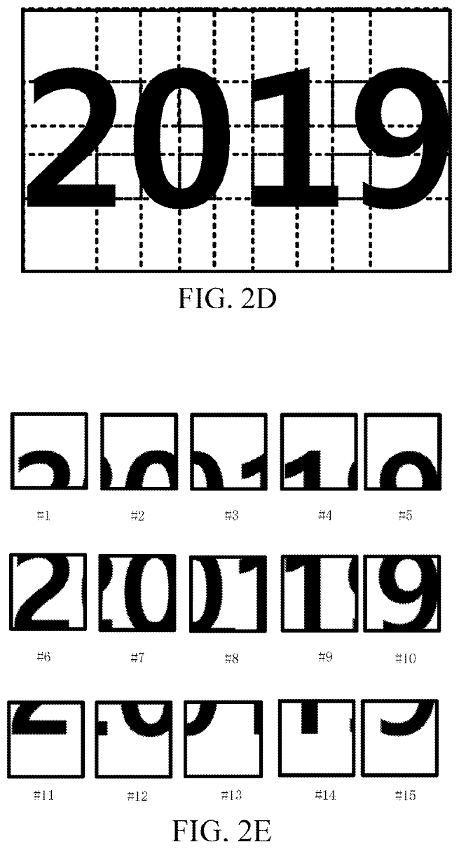

FIG. 2A is a flowchart of a card number recognition method according to another exemplary embodiment. The method includes the following steps:

S201: Obtain a rectangular card image.

Specifically, the rectangular card image may be obtained by using the following method: determining at least three corner pixel positions in an inputted image, where the corner pixel positions are used to represent card vertex angles; according to the at least three corner pixel positions, determining, in the inputted image, an image region for representing a position of the card; and correcting the image region to generate the rectangular card image.

For example, in a process of obtaining a rectangular card image from a photo in which a user holds a card, a corner of the card is covered by a finger and it is difficult to recognize the corner, and only three vertex angles of the card image can be recognized. Therefore, the card image in this case cannot be recognized by using a method of reading four vertex angles and connecting lines to determine a card image. In this case, pixels in positions of the three corners may be connected, an image region obtained after the connection may be mirror flipped along a longest side, to obtain an image region for representing a position of the card, and a shape of the image region may be corrected to generate the rectangular card image.

The manner of recognizing a vertex angle is faster than that of recognizing an edge of a card, and reduces recognition failures caused by distortion generated during image shooting. Moreover, because a card image may be determined based on three vertex angles, recognition errors caused because an edge and a vertex angle of the card are covered can be reduced.

Further, an inclination of the image may be corrected through affine transformation. Card vertex detection replaces edge extraction to extract the image region, which can effectively reduce redundant calculation and accelerate operation of an overall process.

S202: Generate a virtual detection surface that covers the card image, where the virtual detection surface includes a plurality of virtual detection strips that are in parallel with a long side of the card image and that pass through the card image.

As shown in FIG. 2B, the card image has the plurality of virtual detection strips that are in parallel with the long side of the card image and that pass through the card image (only four virtual detection strips 221 to 224 are shown for ease of observation). A length of the virtual detection strip (a horizontal length of the virtual detection strip in FIG. 2B) is the same as a length of the longest side of the card image. A width of the virtual detection strip (a vertical length of the virtual detection strip in FIG. 2B) can be any pixel that facilitates extraction of an image feature, for example, may be 2 pixels, 4 pixels, 5 pixels, or 6 pixels. A specific width of the virtual detection strip is not limited in this embodiment of the present disclosure.

S203: According to a preset image feature, determine a target virtual detection strip intersecting more than a first preset quantity of characters.

The preset image feature includes an image feature that represents that the virtual detection strip intersects the character. In this method, an image feature generated when a virtual detection strip intersects each part of each number is stored in advance. By comparing whether an image of a region of the target virtual detection strip conforms to the image feature, it may be determined whether the target virtual detection strip intersects characters. As shown on the card image in FIG. 2B, the virtual detection strips 223 and 224 intersect characters, and the virtual detection strips 221 and 222 do not intersect characters.

It should be noted that during determining of the target image based on the target virtual detection strip, because of the existence of a complex background pattern, a position in which the virtual detection strip intersects the background pattern may generate an image feature similar to that generated when the virtual detection strip intersects a character. If it is determined that a virtual detection strip that intersects one character that conforms to the image feature is the target virtual detection strip, the position of the target image may be incorrectly recognized.

Therefore, it may be determined that the virtual detection strip that intersects more than first preset quantity of characters is the target virtual detection strip. According to a type of card numbers to be recognized, the first quantity may be preset according to a quantity of characters included in the card numbers. The first preset quantity may be 5, 10, 15, or the like. This is not limited in this embodiment of the present disclosure.

S204: Capture the target image from the card image according to a pixel position that corresponds to the target virtual detection strip and that is of the card image.

In this step, a position of the target image of the character sequence may be determined based on the position of the target virtual detection strip, to capture the target image.

In an optional implementation, a second preset quantity of continuous target virtual detection strips may be selected as a target virtual detection strip group, and an image region that includes at least the target virtual detection strip group and that has a preset size may be captured from the card image as the target image. Alternatively, an image region that includes the target virtual detection strip group and does not include another virtual detection strip is captured as the target image.

For example, the second preset quantity may be 25. If there are 25 continuous target virtual detection strips, the 25 continuous target virtual detection strips may be used as the target virtual detection strip group. A pixel size of the target virtual detection strip group in the card image may be 428×50, and the preset size may be 428×60. In this case, an image that includes a region of the target virtual detection strip group and that has a preset size may be selected as the target image.

In this way, a region of the card numbers is roughly located, so that an image size of entering card numbers to recognize a neural network is reduced, thereby accelerating subsequent recognition.

S205: According to the preset image feature, determine, in the target image, a pixel position in which the target virtual detection strip intersects the characters.

The preset image feature includes an image feature that represents that the virtual detection strip intersects the character. In this method, an image feature generated when a virtual detection strip intersects each part of each number is stored in advance. By comparing whether an image of a region of the virtual detection strip conforms to the image feature, it may be determined whether the virtual detection strip intersects characters. As shown in FIG. 2B, the virtual detection strips 223 and 224 intersect characters, and the virtual detection strips 221 and 222 do not intersect characters.

S206: Obtain the character bit spacing information in the distribution format information according to a pixel position in which at least one target virtual detection strip intersects each character.

In this step, the character bit spacing information in the distribution format information may be obtained based on a spacing between character pixels that intersect the target virtual detection strip. The character bit spacing information may be a list, for example, the character bit spacing information may be 4, 4, 4, 10, 4, 4, 4, which indicates that “the first character and the second character are spaced by 4 pixels, . . . , the fourth character and the fifth character are spaced by 10 pixels, . . . , and so on”. Because there are a plurality of target virtual detection strips that intersect characters, the character bit spacing information may be a list of spacing between character pixels on any target virtual detection strip (for example, a target virtual detection strip in the center) at a fixed position of all target virtual detection strips that intersect characters. This is not limited in the present disclosure.

S207: Recognize a character sequence in a target image through a neural network model trained in advance, and obtain character bit spacing information of the recognized character sequence.

Specifically, the character sequence in the target image may be recognized, and the character bit spacing information of the recognized character sequence may be obtained in the following possible implementation:

First, a plurality of sub-images are acquired from the target image through a plurality of preset sampling windows.

Each position in the target image may appear in at least one sampling window. The sampling windows may be arranged in parallel without overlapping, or may be distributed in a form of an array with adjacent sampling windows partially overlapping.

In a possible implementation, the sampling windows may be distributed in a form of an array, sampling windows in each row of the array are distributed along a horizontal direction of the target image, and two neighboring sampling windows of the sampling windows in each row of the array are spaced by a preset step and partially overlap.

FIG. 2C is a schematic diagram of distribution of a sampling window. There are 15 sampling windows in the target image in the schematic diagram. As shown by dashed boxes, there are 3 rows and 5 columns in total. The first row is a sampling window 1, a sampling window 2, a sampling window 3, a sampling window 4, and a sampling window 5 sequentially from left to right. Other columns are similar thereto. Sampling windows indicated by solid boxes are the sampling window 1, the sampling window 3, and a sampling window 15 sequentially. The sampling windows arranged in this manner can cover the entire target image, and are overlapped in boundaries, which can reduce recognition errors caused by presence of a character in a boundary in which the image is divided.

In an optional implementation of this embodiment, a size of the target image is a preset pixel size, and a size and an arrangement manner of the sampling window are also preset. Therefore, a standard parameter of a processing procedure may be customized according to preset values. During processing of different target images, refer to an implementation of the standard parameter of the processing procedure, to reduce redundant calculation and improve efficiency of card number recognition.

Then, a character label corresponding to each sub-image is recognized according to the neural network model trained in advance.

A classifier label of the neural network model trained in advance may include: a character-type label corresponding to an image feature of each number character in different printing styles; and a space label corresponding to an image feature of a region without a character. The different printing styles may be flat printing, relief imprinting, intaglio imprinting, and the like. Image features and character spacing corresponding to different printing manners are very different. Because numbers in different fonts are also very different, image features of numbers in different fonts may be further added for each type label.

For example, classifier labels may be set to 21 types, respectively corresponding to printed numbers 0 to 9, imprinted recessed and embossed numbers 0 to 9, and background (no number output). Each number may correspond to two classifier labels, that is, a label of a printed number and a label of an imprinted recessed and embossed number. In this way, a number can be recognized more precisely, which can be applied to a scenario with imprinted fonts such as cast steel reference numbers.

The character label corresponding to the sub-image may be a character label with a highest probability of all possible classifier character labels corresponding to the sub-image. The probability of the character label may be model similarity between the sub-image and the corresponding character label.

Then, a target sub-image whose probability of corresponding to the character label satisfies a probability condition is determined in the plurality of sub-images based on a non-maximum suppression algorithm.

Each sub-image may correspond to a recognition result in a position of the target image. If a position of the target image corresponds to a plurality of sub-images, it may be determined that a sub-image whose probability of corresponding to the character label satisfies the probability condition is the target sub-image. The probability condition may be that a sub-image of a plurality of sub-images has a highest probability, or a probability of a sub-image of a plurality of sub-images exceeds a probability threshold.

Specifically, in a possible implementation, the sampling windows are distributed in a form of an array, sampling windows in each row of the array are distributed along a horizontal direction of the target image, and two neighboring sampling windows of the sampling windows in each row of the array are spaced by a preset step and partially overlap. After character labels and probabilities corresponding to sub-images are obtained, the character labels and the probabilities may be arranged in an arrangement manner of the sampling windows. For example, if the target image is recognized according to the sampling windows in FIG. 2D, sub-images #1 to #15 arranged in a sequence of 1 to 15 shown in FIG. 2E are obtained. A former number in brackets represents a character label, and a latter number in the brackets represents a percentage of a probability of the character label. Then, character labels and probabilities corresponding to the sub-images in FIG. 2E are (2, 80), (6, 75), (0, 85), (7, 41), (6, 56), (2, 90), (0, 94), (0, 85), (1, 98), (9, 98), (2, 78), (0, 40), (6, 50), (1, 95), and (9, 80). Therefore, the recognition results may be arranged in the same arrangement manner as the sampling windows as follows:

(2, 80), (6, 75), (0, 85), (7, 41), (6, 56)
(2, 90), (0, 94), (0, 85), (1, 98), (9, 98)
(2, 78), (0, 40), (6, 50), (1, 95), (9, 80).

After the recognition results are arranged in the arrangement sequence of the sampling windows, a determined row of sub-images with a highest sum of probabilities are determined in a plurality of rows of sub-images acquired in a plurality of rows of sampling windows.

A sum of probabilities of each row may be calculated, to determine a recognition result of a row with a highest sum. It is determined that a row of sub-images corresponding to the recognition result are the determined row of sub-images based on the recognition result. For example, in recognition results of the above three rows, because the recognize result of the second row has the highest sum of probabilities, it may be obtained that the determined row of sub-images with the highest sum of probabilities are sub-images acquired in the second row of sampling windows, that is, the second row of sub-images shown in FIG. 2E.

After the recognition result of the row with the highest sum is determined, a target sub-image whose probability of corresponding to the character label satisfies a probability condition is determined in the determined row of sub-images based on a non-maximum suppression algorithm.

Satisfying the probability condition may be having a highest probability. To be specific, the determining a target sub-image whose probability of corresponding to the character label satisfies a probability condition may be: determining that a sub-image that is most similar to (that is, that has a highest probability) a preset model and that is of sub-images corresponding to pixel positions of characters is the target sub-image.

As shown in FIG. 2E, a pixel position of a character 0 corresponds to a sub-image 7 and a sub-image 8. In the two sub-images, because a probability of the sub-image 7 is the highest, it may be determined that the sub-image 7 is the target sub-image.

Then, the character sequence is generated according to a character label corresponding to the target sub-image.

Each character corresponds to a target sub-image. Character labels in recognize results of all target sub-images may be arranged according to an arrangement sequence of the target sub-images, to obtain the character sequence.

For example, a character sequence generated by target sub-images (a sub-image 6, a sub-image 7, a sub-image 9, and a sub-image 10) determined in the target image shown in FIG. 2E is 2019.

Finally, the character bit spacing information of the character sequence is determined according to a pixel position of the target sub-image.

The character spacing may be determined based on a spacing between character pixels represented by target sub-images. The character spacing may be a list, for example, the character spacing may be 4, 4, 4, 10, 4, 4, 4, which indicates that “the first character and the second character are spaced by 4 pixels, . . . , the fourth character and the fifth character are spaced by 10 pixels, . . . , and so on”. Because character spacings may be different in different pixel positions, the character spacing may be a list of spacings between character pixels in any positions (for example, a pixel position of a horizontal center line of the target sub-image). This is not limited in the present disclosure.

S208: Determine whether the character bit spacing information of the recognized character sequence is consistent with the character bit spacing information in the obtained distribution format information.

In this step, the character bit spacing information of the character sequence may be compared with the character bit spacing information in the distribution format information, to determine whether the character bit spacing information of the recognized character sequence is consistent with the character bit spacing information in the distribution format information.

For example, the character bit spacing information obtained in the distribution format information is (4, 4, 4, 10, 4, 4, 10, 4, 4, 4), and represents a total of 11 numbers. In addition, because a spacing between the fourth number and the fifth number and a spacing between the seventh number and the eighth number are obviously larger than that between other positions, it may be determined that a sequence format is XXXX-XXX-XXXX. However, the character bit spacing information obtained in the character sequence is (4, 4, 19, 4, 4, 10, 4, 4, 4). Therefore, a sequence format is determined as XXX-XXX-XXXX, and character bit spacing information of the third number and the fourth number is obviously inconsistent with character spacing information in the distribution format information. Therefore, this indicates that recognition of the third number and the fourth number is wrong.

It should be noted that, in addition to obtaining the distribution format information in steps S202 to S207, during specific implementation, the distribution format information may be further obtained in the following manner obtaining type information of the card number, and determining the distribution format information of the character bit of the card number sequence according to the type information of the card number and a correspondence between a preset card number type and distribution format information of the card number.

If the character bit spacing information of the character sequence is consistent with the character bit spacing information in the distribution format information, perform step S210. If the character bit spacing information of the recognized character sequence is inconsistent with the character bit spacing information in the distribution format information, perform step S209.

S209: Update the character sequence according to the distribution format information, and perform step S210.

Specifically, the character sequence may be updated in the following manner deleting a character that does not conform to the distribution format information from the character sequence, determining, in the determined row of sub-images, a to-be-selected sub-image whose pixel position satisfies a character bit of the distribution format information, and updating the character sequence according to a character label corresponding to the to-be-selected sub-image.

For example, as shown in FIG. 1B, a character sequence format represented by the character bit spacing information in the distribution format information is XXX-XXXX-XXXX (the first row in the figure), and a character sequence format represented by the character bit spacing information of the character sequence is XXXX-XXX-XXXX (the second row in the figure, where numbers represent a sequence of characters). It may be determined that the fourth character in the character sequence is recognized for a plurality of times, and a character between the seventh character and the eighth character is not recognized. The fourth character in the character sequence may be deleted, a to-be-selected sub-image is determined in a pixel position between pixel positions corresponding to the seventh character and the eighth character of the determined row of sub-images, content of the to-be-selected sub-image is recognized again to determine a result of a character between the seventh character and the eighth character, the character sequence is updated to XXX-XXXX-XXXX (the third row in the figure, where numbers represent a sequence of characters) according to the result of the character, and then perform step S210.

S210: Perform a preset check algorithm test on the character sequence; and determine whether the character sequence passes the test.

Because card numbers issued by a card issuer usually satisfy a check algorithm, the corresponding preset check algorithm test may be performed on the character sequence after the character sequence is obtained.

For example, when the recognized character sequence is bank card numbers, a Luhn test (also referred to as a modulus 10 test) may be performed. The Luhn test may detect a single-code error and a transposition error of adjacent numbers, and may be used for testing bank card numbers and ID card numbers. In addition, the preset check algorithm may further be other verification algorithms such as a Verhoeff algorithm. A specific form of the preset check algorithm is not limited in this embodiment of the present disclosure.

S211: If the character sequence does not pass the preset check algorithm test, repeatedly modify the distribution format information, update the character sequence according to the distribution format information, and perform the step of determining whether the updated character sequence passes the preset check algorithm test, until the updated character sequence passes the preset check algorithm test.

If the character sequence does not pass the preset check algorithm, this indicates that the character sequence does not comply with an issuance rule, that is, the character sequence is incorrect. Because a character recognized for a plurality of times and a character not recognized have been corrected in S209, in this step, the character sequence may be incorrect because the character bit spacing information in the distribution format information determined in S206 is incorrect, and environmental factors such as an angle and lighting of shooting a card photo interfere with recognition of the distribution format information.

Therefore, format matching may be sequentially performed on a plurality of pre-stored card number formats, that is, any preset format is determined in the plurality of pre-stored card number formats. The distribution format information is modified according to the preset format. Perform the step of updating the character sequence in S209, and perform the step of performing the preset check algorithm test in S210 again. If the character sequence does not pass the preset check algorithm test, another preset format is determined in the plurality of pre-stored card number formats, and repeatedly perform the above steps of updating and testing until the updated character sequence can pass the preset check algorithm.

S212: Determine the character sequence that passes the preset check algorithm test as the target card numbers.

The above technical solution can at least achieve the following technical effects. Images that need to be precisely recognized can be reduced by determining the card image, thereby accelerating subsequent recognition. Further, the distribution format information may be recognized in advance based on the virtual detection strip. The obtained distribution format information conforms to actual distribution of card numbers, and provides an effective comparison reference for a subsequent recognition result. The distribution format information is recognized in advance and a format of the recognized character sequence is compared with that in the distribution format information. A character in an inconsistent position is updated and then the preset algorithm test is performed. The character sequence that does not pass the test is updated until the character sequence passes the preset algorithm test, which improves an error correction ability of card number recognition. In this solution, an error that occurs during recognition may be further corrected by a subsequent test, which can reduce recognition errors caused by extra or missing characters, or the like. In addition, the recognized character sequence meets a format requirement of an issuer, thereby improving accuracy of card number recognition.

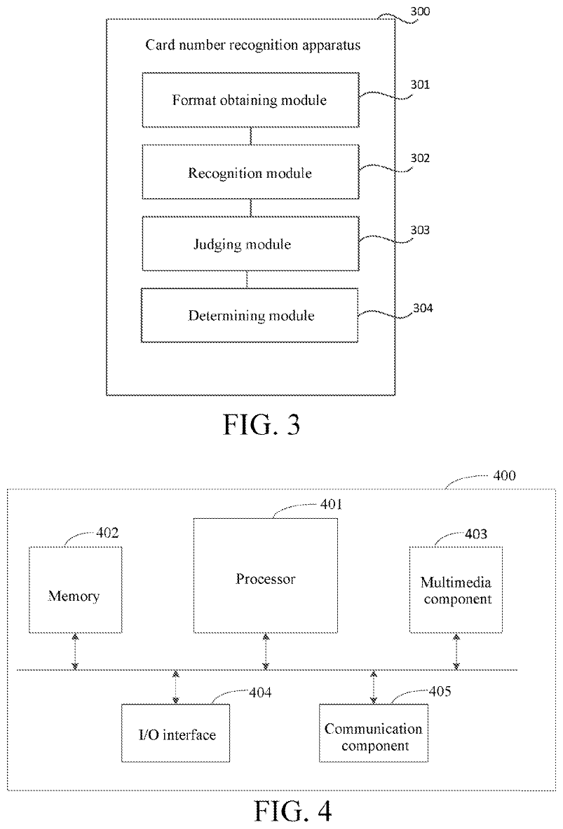

FIG. 3 is a block diagram of a card number recognition apparatus 300 according to an exemplary embodiment. The apparatus includes the following modules:

a format obtaining module 301, configured to obtain distribution format information of character bits of a card number sequence, where the distribution format information includes character bit spacing information of the card number sequence;

S12: Recognize a character sequence in a target image through a neural network model trained in advance, and obtain character bit spacing information of the recognized character sequence.

S13: Determine whether the character bit spacing information of the recognized character sequence is consistent with the character bit spacing information in the obtained distribution format information.

a determining module 304, configured to: when it is determined that the character bit spacing information of the character sequence is consistent with the character bit spacing information in the distribution format information, determine that the recognized character sequence is target card numbers.

The above technical solution can achieve at least the following technical effects: a format of the recognized character sequence is compared with that in the distribution format information, so that it may be determined whether the format of the recognized character sequence is consistent with the format in the distribution format information. If the format of the recognized character sequence is consistent with the format in the distribution format information, the target card numbers are outputted. Therefore, this can reduce recognition errors caused by extra or missing characters, thereby improving accuracy of card number recognition.

Optionally, the apparatus further includes: an image obtaining module, configured to obtain a rectangular card image; a generation module, configured to generate a virtual detection surface that covers the card image, where the virtual detection surface includes a plurality of virtual detection strips that are in parallel with a long side of the card image and that pass through the card image; a target determining module, configured to: according to a preset image feature, determine a target virtual detection strip intersecting more than a first preset quantity of characters in the virtual detection strips, where the preset image feature includes an image feature that represents that the virtual detection strip intersects the character; and an image capturing module, configured to capture the target image from the card image according to a pixel position that corresponds to the target virtual detection strip and that is of the card image.

Optionally, the image capturing module is configured to: select a second preset quantity of continuous target virtual detection strips as a target virtual detection strip group, and capture an image region that includes at least the target virtual detection strip group and that has a preset size from the card image as the target image.

Optionally, the image obtaining module is configured to: determine at least three corner pixel positions in an inputted image, where the corner pixel positions are used to represent card vertex angles; according to the at least three corner pixel positions, determine, in the inputted image, an image region for representing a position of the card; and correct the image region to generate the rectangular card image.

Optionally, the format obtaining module is configured to: according to the preset image feature, determine, in the target image, a pixel position in which the target virtual detection strip intersects the characters; and determine the character bit spacing information in the distribution format information according to a pixel position in which at least one target virtual detection strip intersects each character.

Optionally, the format obtaining module is further configured to: obtain type information of the card number, and determine the distribution format information of the character bit of the card number sequence according to the type information of the card number and a correspondence between a preset card number type and distribution format information of the card number.

Optionally, the recognition module includes: a sampling submodule, configured to acquire a plurality of sub-images from the target image through a plurality of preset sampling windows; a recognition submodule, configured to recognize, according to the neural network model trained in advance, a character label corresponding to each sub-image; a first determining submodule, configured to determine a target sub-image whose probability of corresponding to the character label satisfies a probability condition in the plurality of sub-images based on a non-maximum suppression algorithm; a generation submodule, configured to generate the character sequence according to a character label corresponding to the target sub-image; and a second determining submodule, configured to determine the character bit spacing information of the character sequence according to a pixel position of the target sub-image.

Optionally, the plurality of sampling windows are distributed in a form of an array, sampling windows in each row of the array are distributed along a horizontal direction of the target image, and two neighboring sampling windows of the sampling windows in each row of the array are spaced by a preset step and partially overlap. The first determining submodule is configured to: obtain a probability that each sub-image corresponds to the character label; determine a row of sub-images with a highest sum of probabilities as a determined row of sub-images in a plurality of rows of sub-images acquired in a plurality of rows of sampling windows; and determine a target sub-image whose probability of corresponding to the character label satisfies a probability condition in the determined row of sub-images based on a non-maximum suppression algorithm.

Optionally, a classifier label of the neural network model trained in advance includes: a character-type label corresponding to an image feature of each number character in different printing styles; and a space label corresponding to an image feature of a region without a character.

Optionally, the apparatus further includes: an update module, configured to: when the character bit spacing information of the recognized character sequence is inconsistent with the character bit spacing information in the obtained distribution format information, update the character sequence according to the distribution format information.

Optionally, the update module is configured to: delete a character that does not conform to the distribution format information from the character sequence; and/or determine, in the determined row of sub-images, a to-be-selected sub-image whose pixel position satisfies a character bit of the distribution format information, and update the character sequence according to a character label corresponding to the to-be-selected sub-image.

Optionally, the apparatus further includes: a check module, configured to: determine whether the character sequence passes a preset check algorithm test; and when the character sequence does not pass the preset check algorithm test, repeatedly modify the distribution format information, update the character sequence according to the distribution format information, and perform the step of determining whether the updated character sequence passes the preset check algorithm test, until the updated character sequence passes the preset check algorithm test.

The determining module is configured to determine the character sequence that passes the preset check algorithm test as the target card numbers.

The above technical solution can at least achieve the following technical effects. Images that need to be precisely recognized can be reduced by determining the card image, thereby accelerating subsequent recognition. Further, the distribution format information may be recognized in advance based on the virtual detection strip. The obtained distribution format information conforms to actual distribution of card numbers, and provides an effective comparison reference for a subsequent recognition result. In addition, the distribution format information is recognized in advance and a format of the recognized character sequence is compared with that of the distribution format information. A character in an inconsistent position is updated and then the preset algorithm test is performed. The character sequence that does not pass the test is updated until the character sequence passes the preset algorithm test. Therefore, this can reduce recognition errors caused by extra or missing characters. In addition, the recognized character sequence meets a format requirement of an issuer, thereby improving accuracy of card number recognition.

A person skilled in the art may clearly understand that for convenience and conciseness of description, the division of the foregoing functional units (modules) is merely used as an example for description. In practical application, the foregoing functions may be allocated to and completed by different function units (modules) according to requirements, that is, the internal structure of the apparatus is divided into different function units (modules), so as to complete all or part of the functions described above. For specific working processes of the functional units (modules) described above, reference may be made to the corresponding processes in the foregoing method embodiments, and details are not described herein again.

An embodiment of the present disclosure further provides a nonvolatile computer-readable storage medium, storing a computer program. When the program is executed by a processor, the steps of the foregoing card number recognition method are implemented.

An embodiment of the present disclosure further provides an electronic device, including: a memory, storing a computer program; and a processor, configured to execute the computer program in the memory, to perform the steps of the foregoing card number recognition method.

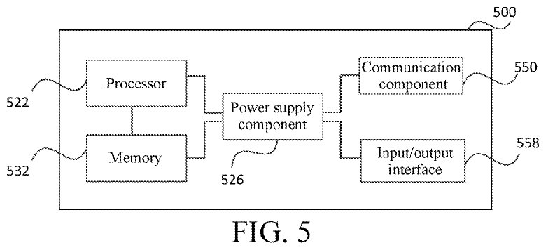

FIG. 4 is a block diagram of an electronic device 400 according to an exemplary embodiment. The electronic device 400 can be provided as a smart phone, a smart tablet device, a personal financial management terminal, or the like. As shown in FIG. 4, the electronic device 400 may include: a processor 401 and a memory 402. The electronic device 400 may further include one or more of a multimedia component 403, an input/output (I/O) interface 404, and a communication component 405.

The processor 401 is configured to control an overall operation of the electronic device 400 to complete some or all steps of the foregoing card number recognition method. The memory 402 is configured to store various types of data to support an operation on the electronic device 400. The data may include, for example, instructions for any application or method to operate on the electronic device 400, and application-related data, for example, data of a convolutional neural network model trained in advance and data of a card image to be recognized, and may also include pre-stored format information. The memory 402 may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The multimedia component 403 may include a screen and an audio component. The screen may be a touch screen, and the audio component is configured to output and/or input an audio signal. For example, the audio component may include a microphone, configured to receive an external audio signal. The received audio signal may be further stored in the memory 402 or sent by the communication component 405. The audio component also includes at least one speaker configured to output an audio signal. The I/O interface 404 provides an interface between the processor 401 and another interface module. The another interface module may be a keyboard, a mouse, a button, and the like. These buttons may be virtual buttons or physical buttons. The communication component 405 is configured to perform wired or wireless communication between the electronic device 400 and another device. The wireless communication is, for example, Wi-Fi, Bluetooth, near field communication (NFC), 2G, 3G, or 4G, or a combination of one or more thereof. Therefore, the corresponding communication component 405 may include: a Wi-Fi module, a Bluetooth module, and an NFC module.

In an exemplary embodiment, the electronic device 400 may be implemented by one or more application-specific integrated circuits (ASIC), a digital signal processor (DSP), a digital signal processing device (DSPD), a programmable logic device (PLD), a field-programmable gate array (PFGA), a controller, a micro-controller, a micro-processor, or another electronic element, to implement the foregoing card number recognition method.

In another exemplary embodiment, a computer-readable storage medium including program instructions is further provided. The program instructions, when executed by a processor, perform the steps of the foregoing card number recognition method. For example, the computer-readable storage medium may be the memory 402 including program instructions, and the program instructions may be executed by the processor 401 of the electronic device 400 to implement the foregoing card number recognition method.

FIG. 5 is a block diagram of an electronic device 500 according to another exemplary embodiment. For example, the electronic device 500 may be provided as a server. Referring to FIG. 5, the electronic device 500 includes a processor 522, where there may be one or more processors 522, and a memory 532 configured to store a computer program executable by the processor 522. The computer program stored in the memory 532 may include one or more modules, where each module corresponds to a set of instructions. In addition, the processor 522 may be configured to execute the computer program to implement the foregoing card number recognition method.

In addition, the electronic device 500 may further include a power supply component 526 and a communication component 550. The power supply component 526 may be configured to perform power management of the electronic device 500, and the communication component 550 may be configured to implement communication of the electronic device 500, for example, wired or wireless communication. In addition, the electronic device 500 may further include an I/O interface 558. The electronic device 500 can operate an operating system stored in the memory 532, for example, Windows Server™, Mac OS X™, Unix™, and Linux™.

In another exemplary embodiment, a computer-readable storage medium including program instructions is further provided. The program instructions, when executed by a processor, perform the steps of the foregoing card number recognition method. For example, the computer-readable storage medium may be the memory 532 including program instructions, and the program instructions may be executed by the processor 522 of the electronic device 500 to implement the foregoing card number recognition method.

The exemplary implementations of the present disclosure are described in detail above with reference to the accompanying drawings. However, the present disclosure is not limited to the specific details in the foregoing implementations, a plurality of simple deformations may be made to the technical solution of the present disclosure within a range of the technical concept of the present disclosure, and these simple deformations fall within the protection scope of the present disclosure.

It should be additionally noted that, the specific technical features described in the foregoing specific implementations may be combined in any proper manner in a case without conflict. To avoid unnecessary repetition, various possible combination manners are not described in the present disclosure.

In addition, different implementations of the present disclosure may also be arbitrarily combined without departing from the idea of the present disclosure, and these combinations shall still be regarded as content disclosed in the present disclosure.

1. A card number recognition method, wherein the method comprises:
obtaining distribution format information of character bits of a card number sequence, wherein the distribution format information comprises character bit spacing information of the card number sequence;
recognizing a character sequence in a target image through a neural network model trained in advance, and obtaining character bit spacing information of the recognized character sequence;
determining whether the character bit spacing information of the recognized character sequence is consistent with the character bit spacing information in the obtained distribution format information; and
if the character bit spacing information of the character sequence is consistent with the character bit spacing information in the obtained distribution format information, determining that the recognized character sequence is target card numbers.

2. The method according to claim 1, wherein the method further comprises:
obtaining a rectangular card image;
generating a virtual detection surface that covers the card image, wherein the virtual detection surface comprises a plurality of virtual detection strips that are in parallel with a long side of the card image and that pass through the card image;
according to a preset image feature, determining a target virtual detection strip intersecting more than a first preset quantity of characters in the virtual detection strips, wherein the preset image feature comprises an image feature that represents that the virtual detection strip intersects the character; and
capturing the target image from the card image according to a pixel position that corresponds to the target virtual detection strip and that is of the card image.

3. The method according to claim 2, wherein the capturing the target image comprises:
selecting a second preset quantity of continuous target virtual detection strips as a target virtual detection strip group; and
capturing an image region that comprises at least the target virtual detection strip group and that has a preset size from the card image as the target image.

4. The method according to claim 2, wherein the obtaining a rectangular card image comprises:
determining at least three corner pixel positions in an inputted image, wherein the corner pixel positions are used to represent card vertex angles;
according to the at least three corner pixel positions, determining, in the inputted image, an image region for representing a position of the card; and
correcting the image region to generate the rectangular card image.

5. The method according to claim 2, wherein the obtaining distribution format information of character bits of a card number sequence comprises:
according to the preset image feature, determining, in the target image, a pixel position in which the target virtual detection strip intersects the characters; and
determining the character bit spacing information in the distribution format information according to a pixel position in which at least one target virtual detection strip intersects each character.

6. The method according to claim 1, wherein the obtaining distribution format information of character bits of a card number sequence comprises:
obtaining type information of the card number; and
determining the distribution format information of the character bit of the card number sequence according to the type information of the card number and a correspondence between a preset card number type and distribution format information of the card number.

7. The method according to claim 1, wherein the recognizing a character sequence in a target image through a neural network model trained in advance, and obtaining character bit spacing information of the recognized character sequence comprises:
acquiring a plurality of sub-images from the target image through a plurality of preset sampling windows;
recognizing, according to the neural network model trained in advance, a character label corresponding to each sub-image;
determining a target sub-image whose probability of corresponding to the character label satisfies a probability condition in the plurality of sub-images based on a non-maximum suppression algorithm;
generating the character sequence according to a character label corresponding to the target sub-image; and
determining the character bit spacing information of the character sequence according to a pixel position of the target sub-image.

8. The method according to claim 7, wherein the plurality of sampling windows are distributed in a form of an array, sampling windows in each row of the array are distributed along a horizontal direction of the target image, and two neighboring sampling windows of the sampling windows in each row of the array are spaced by a preset step and partially overlap; and
the determining a target sub-image comprises:
obtaining a probability that each sub-image corresponds to the character label;
determining a row of sub-images with a highest sum of probabilities as a determined row of sub-images in a plurality of rows of sub-images acquired in a plurality of rows of sampling windows; and
based on the non-maximum suppression algorithm, determining, in the determined row of sub-images, the target sub-image whose probability of corresponding to the character label satisfies the condition.

9. The method according to claim 7, wherein a classifier label of the neural network model trained in advance comprises:
a character-type label corresponding to an image feature of each number character in different printing styles; and
a space label corresponding to an image feature of a region without a character.

10. The method according to claim 8, wherein the method further comprises:
if the character bit spacing information of the recognized character sequence is inconsistent with the character bit spacing information in the distribution format information, updating the character sequence according to the distribution format information.

11. The method according to claim 10, wherein the updating the character sequence according to the distribution format information comprises:
deleting a character that does not conform to the distribution format information from the character sequence; and/or
determining, in the determined row of sub-images, a to-be-selected sub-image whose pixel position satisfies a character bit of the distribution format information, and updating the character sequence according to a character label corresponding to the to-be-selected sub-image.

12. The method according to claim 10, wherein before the determining that the recognized character sequence is the target card numbers, the method further comprises:
determining whether the character sequence passes a preset check algorithm test; and
if the character sequence does not pass the preset check algorithm test, repeatedly modifying the distribution format information, updating the character sequence according to the distribution format information, and performing the step of determining whether the updated character sequence passes the preset check algorithm test, until the updated character sequence passes the preset check algorithm test; and
the determining that the recognized character sequence is the target card numbers comprises:
determining the character sequence that passes the preset check algorithm test as the target card numbers.

13. A nonvolatile computer-readable storage medium, storing a computer program, wherein when the program is executed by a processor, the processor is enabled to perform the following operations:
obtaining distribution format information of character bits of a card number sequence, wherein the distribution format information comprises character bit spacing information of the card number sequence;
recognizing a character sequence in a target image through a neural network model trained in advance, and obtaining character bit spacing information of the recognized character sequence;
determining whether the character bit spacing information of the recognized character sequence is consistent with the character bit spacing information in the obtained distribution format information; and
if the character bit spacing information of the character sequence is consistent with the character bit spacing information in the obtained distribution format information, determining that the recognized character sequence is target card numbers.

14. The storage medium according to claim 13, wherein the operations further comprise:
obtaining a rectangular card image;
generating a virtual detection surface that covers the card image, wherein the virtual detection surface comprises a plurality of virtual detection strips that are in parallel with a long side of the card image and that pass through the card image;
according to a preset image feature, determining a target virtual detection strip intersecting more than a first preset quantity of characters in the virtual detection strips, wherein the preset image feature comprises an image feature that represents that the virtual detection strip intersects the character; and
capturing the target image from the card image according to a pixel position that corresponds to the target virtual detection strip and that is of the card image.

15. The storage medium according to claim 14, wherein the operation of capturing the target image comprises:
selecting a second preset quantity of continuous target virtual detection strips as a target virtual detection strip group; and
capturing an image region that comprises at least the target virtual detection strip group and that has a preset size from the card image as the target image.

16. The storage medium according to claim 14, wherein the operation of obtaining a rectangular card image comprises:
determining at least three corner pixel positions in an inputted image, wherein the corner pixel positions are used to represent card vertex angles;
according to the at least three corner pixel positions, determining, in the inputted image, an image region for representing a position of the card; and
correcting the image region to generate the rectangular card image.

17. An electronic device, comprising:
a memory, storing a computer program; and
a processor, configured to execute the computer program in the memory, to perform the following operations:
obtaining distribution format information of character bits of a card number sequence, wherein the distribution format information comprises character bit spacing information of the card number sequence;
recognizing a character sequence in a target image through a neural network model trained in advance, and obtaining character bit spacing information of the recognized character sequence;
determining whether the character bit spacing information of the recognized character sequence is consistent with the character bit spacing information in the obtained distribution format information; and
if the character bit spacing information of the character sequence is consistent with the character bit spacing information in the obtained distribution format information, determining that the recognized character sequence is target card numbers.

18. The electronic device according to claim 17, wherein the operations further comprise:
obtaining a rectangular card image;
generating a virtual detection surface that covers the card image, wherein the virtual detection surface comprises a plurality of virtual detection strips that are in parallel with a long side of the card image and that pass through the card image;
according to a preset image feature, determining a target virtual detection strip intersecting more than a first preset quantity of characters in the virtual detection strips, wherein the preset image feature comprises an image feature that represents that the virtual detection strip intersects the character; and
capturing the target image from the card image according to a pixel position that corresponds to the target virtual detection strip and that is of the card image.

19. The electronic device according to claim 18, wherein the operation of capturing the target image comprises:
selecting a second preset quantity of continuous target virtual detection strips as a target virtual detection strip group; and
capturing an image region that comprises at least the target virtual detection strip group and that has a preset size from the card image as the target image.

20. The electronic device according to claim 18, wherein the operation of obtaining a rectangular card image comprises:
determining at least three corner pixel positions in an inputted image, wherein the corner pixel positions are used to represent card vertex angles;
according to the at least three corner pixel positions, determining, in the inputted image, an image region for representing a position of the card; and
correcting the image region to generate the rectangular card image.
